(19) United States
(12) Patent Application Publication
(10) Pub. No.: US 2017/0148487 A1
(43) Pub. Date: May 25, 2017

(54) Video Manipulation for Privacy Enhancement

(71) Applicant: Dell Products L.P., Round Rock, TX (US)

(72) Inventors: Karthikeyan Krishnakumar, Round Rock, TX (US); Roman Joel Pacheco, Leander, TX (US)

(73) Assignee: Dell Products L.P., Round Rock, TX (US)

(21) Appl. No.: 14/951,967

(22) Filed: Nov. 25, 2015

(51) Int. Cl. G11B 27/031; H04N 7/15; G06T 7/00; G06K 9/62; G06K 9/00; G06K 9/46

(52) U.S. Cl. CPC G11B 27/031; G06K 9/00744; G06K 9/4671; G06T 7/0079; G06K 9/6267; H04N 7/15; G06K 2009/4666; G06T 2207/20144

(57) ABSTRACT

A system, method, and computer-readable medium for performing a selective video manipulation operation for privacy enhancement. More specifically, the selective video manipulation operation detects video transmission protected regions in a scene and applies effects to these regions before transmitting a modified video stream which presents a selectively modified scene. In certain embodiments, the video transmission protected regions include potentially sensitive or distracting regions in the scene. In certain embodiments the selective video manipulation operation automatically detects video transmission protected regions which may be located in at least one of the background of the scene or the foreground attic scene and applies user-configurable effects to the identified regions.

### BACKGROUND OF THE INVENTION

Field of the Invention

The present invention relates to information handling systems. More specifically, embodiments of the invention relate to video manipulation for privacy enhancement.

Description of the Related Art

As the value and use of information continues to increase, individuals and businesses seek additional ways to process and store infbrmation. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

It is known to provide information handling systems with an integrated video camera (e.g., a webcam). For example, all in one type information handling systems or portable type information handling systems may include the video camera within the housing of the system while stand-alone type information handling systems may include the video camera which is associated with the display device of the information handling system. In certain systems the video camera may be integrated with the display device. In other systems, the video camera may be coupled to the information handling system and then located in proximity with the display device. It is known to use the integrated video camera to perform a video conference operation.

Often, during a video conference operation, a user may wish to selectively hide sensitive or distracting information that is present in the background or within the field of view (FOV) of the camera. Certain known background manipulation techniques (e.g. depth-based segmentation/replacement) use an all-or-nothing approach (e.g., by completely removing or replacing the background). However, full manipulation is often not necessary or desirable. For example, a user may simply wish to hide sensitive information on their whiteboard while showing the rest of the background or FOV. Additionally, oftentimes the sensitive information is not present in the background but in the foreground itself.

### SUMMARY OF THE INVENTION

A system, method, and computer-readable medium are disclosed for performing a selective video manipulation operation for privacy enhancement. More specifically, the selective video manipulation operation detects video transmission protected regions in a scene and applies effects to these regions before transmitting a modified video stream which presents a selectively modified scene. In certain embodiments, the video transmission protected regions include potentially sensitive or distracting regions in the scene. In certain embodiments the selective video manipulation operation automatically detects video transmission protected regions which may be located in at least one of the background of the scene or the foreground of the scene and applies user-configurable effects to the identified regions. In certain embodiments, the potentially sensitive or distraction regions in the background of the scene can include one or more of whiteboards, screens, TVs, open doors, windows, etc. In certain embodiments, the potentially sensitive or distraction regions in the foreground of the scene can include one or more of a badge number, 3rd party logo on shirt, etc. In certain embodiments, the selective video manipulation operation is application-independent to ensure compatibility with different video conferencing applications.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of a selective video manipulation environment.

FIG. 3 shows a flow chart of the operation of a selective video manipulation system.

FIGS. 4A and 4B show examples of a scene having a region of interest.

FIGS. 5A and 5B show examples of scene having a region of interest.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

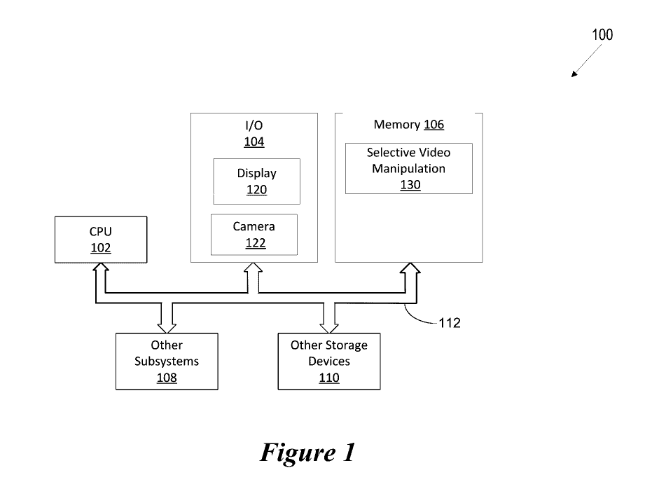

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display device 120, a camera system 122 (such as a multi-modal camera), a keyboard, a mouse, and associated controllers, memory 106, and various other subsystems 108. The information handling system 100 likewise includes other storage devices 110. The components of the information handling system are interconnected via one or more buses 112,

The information handling system also includes a selective video manipulation system 130 within the memory 106 and containing instructions for execution by the processor 102. The selective video manipulation system 130 performs a selective video manipulation operation for privacy enhancement. More specifically, the selective video manipulation operation detects video transmission protected regions in a scene and applies effects to these regions. In certain embodiments, the video transmission protected regions include potentially sensitive or distracting regions in the scene. In certain embodiments the selective video manipulation operation automatically detects video transmission protected regions which may be located in at least one of the background of the scene or the foreground of the scene and applies user-configurable effects to the identified regions. In certain embodiments, the potentially sensitive or distraction regions in the background of the scene can include one or more of whiteboards, screens, TVs, open doors, windows, etc. In certain embodiments, the potentially sensitive or distraction regions in the foreground of the scene can include one or more of a badge number, 3rd party logo on shirt, etc. In certain embodiments, the selective video manipulation operation is application-independent to ensure compatibility with different video conferencing applications.

In certain embodiments, the camera system 122 includes one or both of an RGB camera and a depth camera, thus providing both a 2D and a 3D capture mode. In certain embodiments, the 2D camera generates a 2D image stream which includes a color value on a per pixel basis. In certain embodiments, the 3d camera generates a 3D image stream which includes a color value and a depth value on a per pixel basis. In certain embodiments, the camera system 122 includes an RGB CMOS camera and a time-of-flight depth camera, and can function in a 2D or 3D mode.

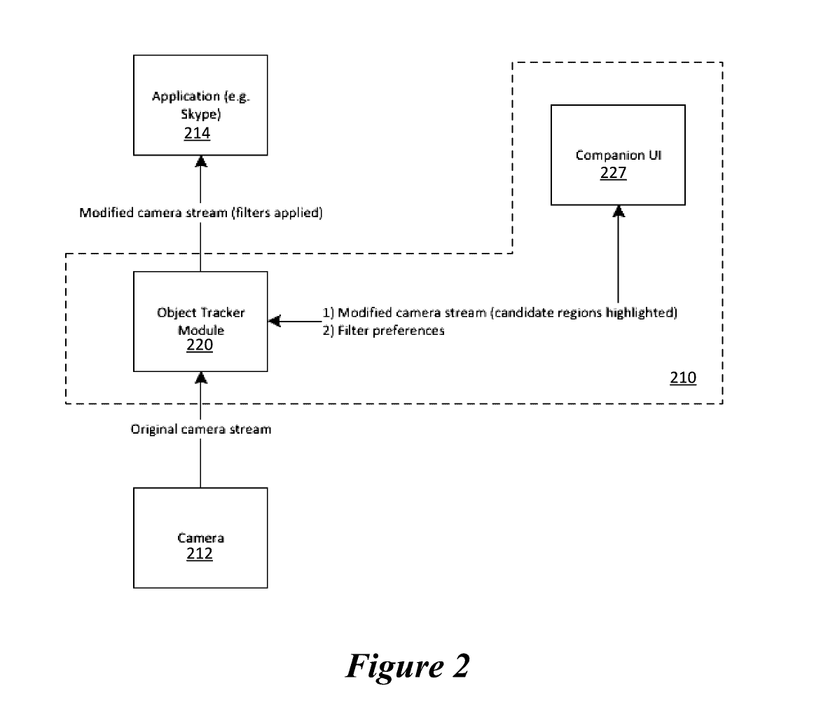

Referring to FIG. 2, a block diagram of a selective video manipulation environment 200 is shown. The selective video manipulation environment 200 includes a selective video manipulation system 210 as well as a camera 212 (such as camera system 122) and an application 214. The selective video manipulation system 210 further includes a region tracking module 220 and a user interface module 222. In various embodiments, the selective video manipulation system 210 performs some or all of the functions of the selective video manipulation module 130.

The selective video manipulation system 210 performs a selective video manipulation operation. The selective video manipulation operation analyzes an incoming camera video stream received from the camera 212. In certain embodiments, the incoming camera video stream may be used for a video conference. The camera video stream may include RGB pixels (if a 2D camera is used) or RGB+Depth pixels (if a 3D camera is used). The camera video stream is then modified to provide a modified video stream which is then provided to an application such as a consuming video conference application (e.g. the Skype video conference application).

The region tracking module 220 processes each image in the camera video stream, analyzes the image to determine object and region boundaries, and automatically identifies which regions may contain may include video transmission protected information. The selective video manipulation module 210 performs object and region segmentation operations based upon one or more of color, texture, edges, and (in the case of depth cameras) distance information in a scene.

In certain embodiments, the selective video manipulation operation can identify certain regions of interest (i.e., special regions) for which additional scrutiny may be applied. In certain embodiments, the regions of interest include a region with text or hand-drawn images such as may be presented on whiteboards. These text or hand-drawn images may be detected using optical character recognition (OCR) and adjacent image classification techniques such as by using object recognition methods in computer vision available from Mathworks, Inc. In certain embodiments, the regions of interest can include a region which includes proprietary company information such as company logos. This proprietary company information may be detected using, for example, training data sets, as well as cloud-based image comparisons. Training data sets refers to the use of an example image to train the selective video manipulation system 200. For example, the selective video manipulation system 200 may include a recognition algorithm which is based on a neural network. For the recognition algorithm to recognize a company logo, the selective video manipulation system 200 is provided with a sample image containing the logo so that the neural network can detect the same logo in new images. In certain embodiments, the regions of interest can include a region which includes regions with sensitive textual information such as printed text (including numbers) as might be presented within badges, projector screens, TV monitors, etc. This sensitive textual information may be detected using OCR and adjacent classification techniques. In certain embodiments, the regions of interest can include a region which includes regions with sensitive image information such as personal photographs. This sensitive image information may be detected using face recognition and other image classification techniques. In certain embodiments, the regions of interest can include a region which includes regions with moving objects. The moving objects could be distracting to recipients of the video transmission. The moving objects may be detected using motion detection techniques, optical flow, face detection, etc.

As images from the camera 220 are processed by the selective video manipulation system 210, the selective video manipulation system 210 maintains a table of the regions of interest that are detected. Using this table, the selective video manipulation system 210 tracks the regions across frames and applies the selected filters for these regions.

The selective video manipulation system 210 includes a user interface module 222 which provides a selective video manipulation user interface to allow a user to ascertain any regions that have been identified by the region tracking module 220. The user interface module 222 also enables a user to configure the filters that are to be applied to the regions identified by the region tracking module 220. In certain embodiments, the user interface module 222 accents (e.g., by highlighting) any regions of interest. In certain embodiments, the user interface module 222 allows a user to manually select additional objects or regions that may not have been automatically identified by the region tracking module 220. Any additional objects or regions identified by the user may also be added to the table identifying regions of interest for further obscuration.

In certain embodiments, the user interface module 222 presents the original camera video stream as well as candidate and user-selected regions highlighted with a graphical aid (e.g. a user-visible bounding box around the region). The user interface module 222 provides controls to allow a user to specify the filter that should be applied to each region. A user can also pre-set default filters based on categories of objects. For example, the user may choose to automatically apply a blur filter to any object that appears to be a whiteboard.

After the regions of interest are identified, the selective video manipulation system 210 applies an effect to the identified regions of interest. In certain embodiments, the effect may be applied to the identified region of interest via a filter operation. The filter operation may include one or more of a blur operation which performs a blur effect, a blank operation in which the region is blanked (i.e., deleted) which performs a blank effect and a green screen operation in which the region is replaced with another image or video which performs a green screen effect. In certain embodiments, different filter operations may be applied to different regions of interest. The different filter operations may be controlled by a user via the user interface.

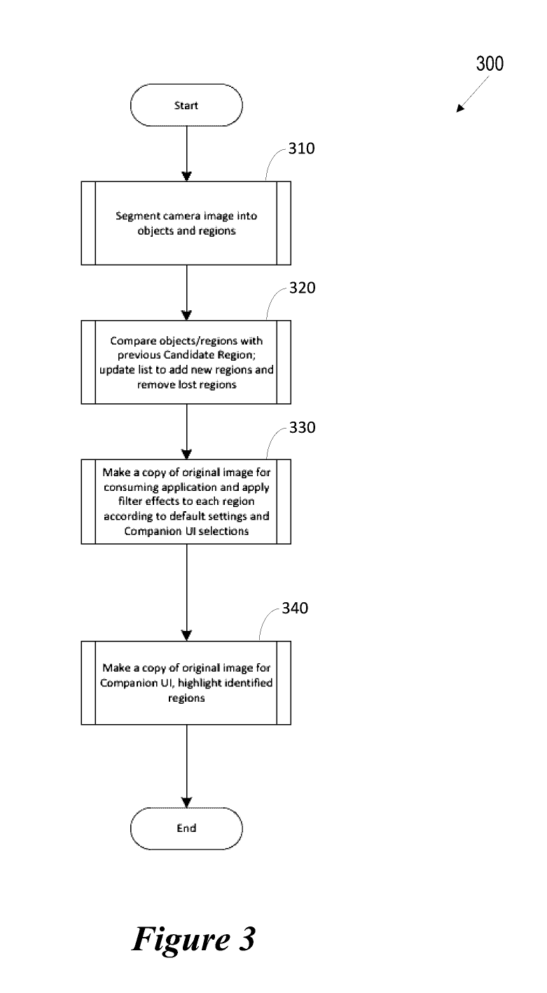

Referring to FIG. 3, a flow chart of the operation 300 of a selective video manipulation system 210 is shown. More specifically, the operation begins at step 310 with the selective video manipulation system 210 segmenting a scene received from the camera 212 into objects and regions. Next at step 320, the selective video manipulation system 210 compares objects and regions with at least one previous candidate region where the at least one candidate region represents a region of interest. The selective video manipulation system 210 then updates a list to add any new regions and/or to remove any lost regions based upon the comparison. Next at step 330, the selective video manipulation system 210 creates a copy of the original image for a consuming application and applies effects to any selected regions of interest according to default settings of the selective video manipulation system 210 as modified by any user selections input via the user interface module 214. Next at step 340, the selective video manipulation system 210 generates a copy of the original scene to be used by the user interface module 214 in accenting identified regions.

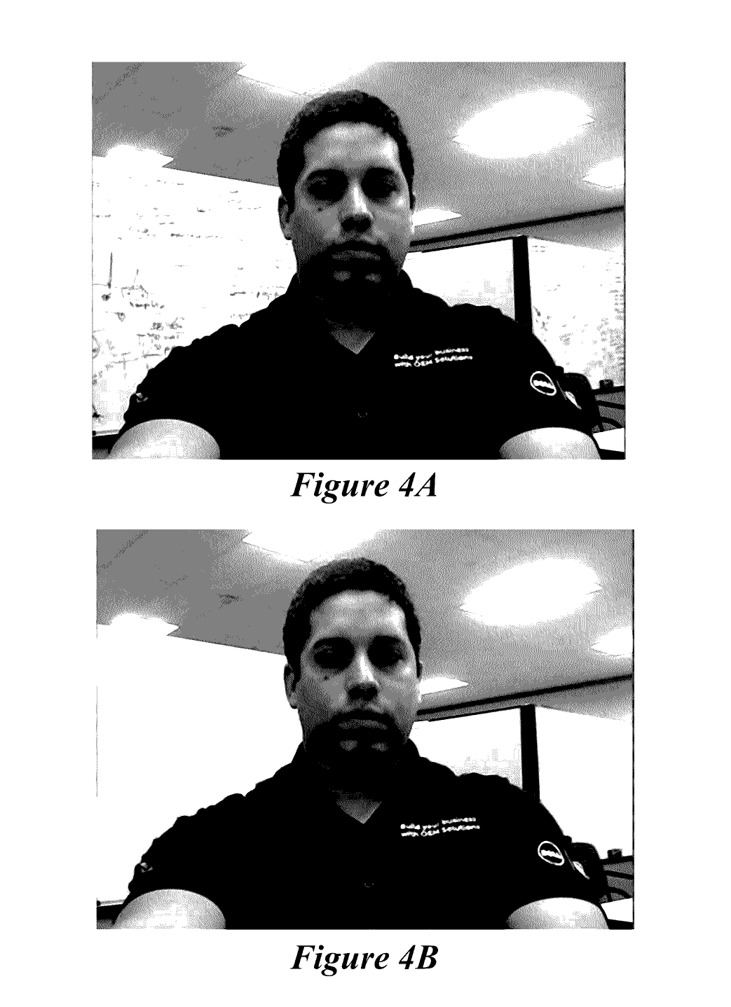

FIGS. 4A and 4B show examples of a scene having a region of interest. More specifically, FIG. 4A shows an example of a scene containing a plurality of regions of interest. In this example, the regions of interest include a plurality of potentially sensitive white board regions containing handwritten text. FIG. 4B shows an example of a scene in which an effect is applied to the regions of interest to delete and clear the regions of interest.

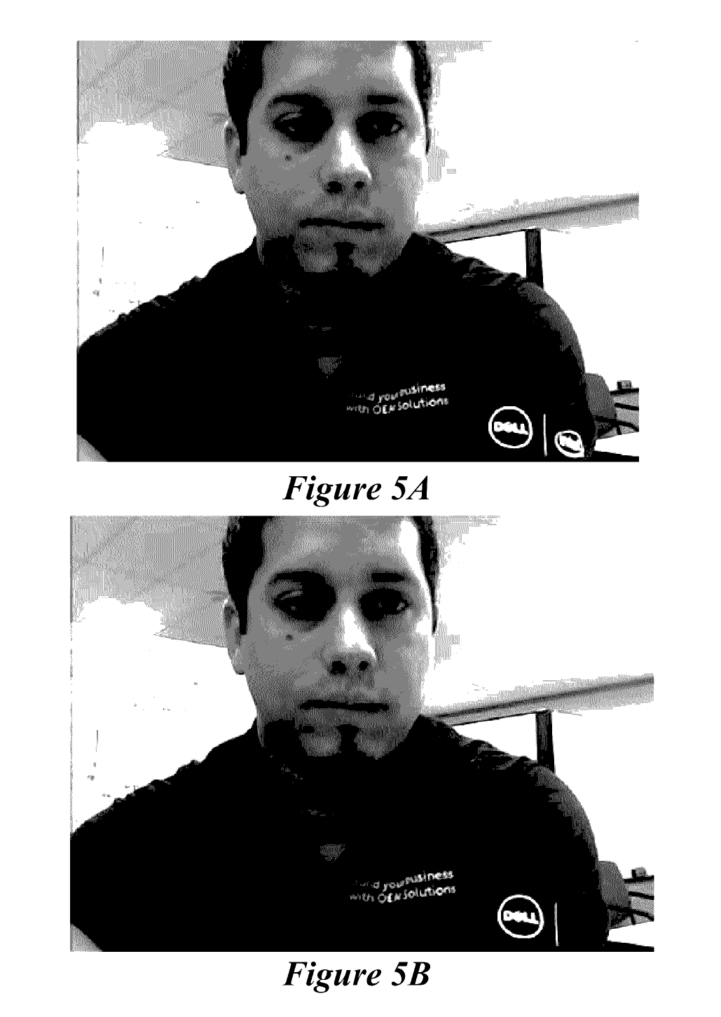

FIGS. 5A and 5B show examples of scene having a region of interest. More specifically, FIG. 5A shows an example of a scene containing a plurality of regions of interest. In this example, the regions of interest include a plurality of potentially sensitive white board regions containing handwritten text as well as regions presenting proprietary company information. FIG. 5B shows an example of a scene in which an effect is applied to a region of interest containing proprietary company information (e.g., a logo of a partner company) while not being applied to another region of interest containing other proprietary company information (e.g., a logo of a company associated with the user). Additionally, in the example shown in FIG. 5B, an effect is not applied to the regions of interest which include a plurality of potentially sensitive white board regions containing handwritten text.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system,” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

1. A computer-implementable method for performing a selective video manipulation operation for privacy enhancement comprising:
receiving an image video stream from a camera, the image video stream representing a scene;
performing an analysis on the image stream provided by camera to identify a region of interest within the scene, the region of interest corresponding to a portion of the scene, the analysis identifying a first subset of the portion of the scene and a second subset of the portion of the scene;
applying an effect to the first subset of the portion of the scene but not to the second subset of the portion of the scene to provide a modified video stream; and,
providing the modified video stream to an application the modified video stream enhancing privacy of the image video stream due to the effect applied to the first subset of the portion of the scene.

2. The method of claim 1, wherein:
the camera comprises a two dimensional camera and a three dimensional camera; and, the two dimensional camera provides a two dimensional image stream and the three dimensional camera provides a three dimensional image stream.

3. The method of claim 1, wherein:
the region of interest comprises a video transmission protected region; and,
the video transmission protected region comprises at least one of potentially sensitive regions and distracting regions in the scene.

4. The method of claim 1, wherein:
the identifying a region of interest comprises at least one of automatically detecting video transmission protected regions which are located in at least one of the background of the scene or the foreground of the scene.

5. The method of claim 1, further comprising:
applying user-configurable effects to the identified region of interest.

6. The method of claim 1, wherein:
the effect comprises at least one of a blur effect, a blank effect and a green screen effect.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
receiving an image video stream from a camera, the image video stream representing a scene;
performing an analysis on the image stream provided by camera to identify a region of interest within the scene, the region of interest corresponding to a portion of the scene, the analysis identifying a first subset of the portion of the scene and a second subset of the portion of the scene;
applying an effect to the first subset of the portion of the scene but not to the second subset of the portion of the scene to provide a modified video stream; and,
providing the modified video stream to an application the modified video stream enhancing privacy of the image video stream due to the effect applied to the first subset of the portion of the scene.

8. The system of claim 7, wherein:
the camera comprises a two dimensional camera and a three dimensional camera; and,
the two dimensional camera provides a two dimensional image stream and the three dimensional camera provides a three dimensional image stream.

9. The system of claim 7, wherein:
the region of interest comprises a video transmission protected region; and,
the video transmission protected region comprises at least one of potentially sensitive regions and distracting regions in the scene.

10. The system of claim 7, wherein:
the identifying a region of interest comprises at least one of automatically detecting video transmission protected regions which are located in at least one of the background of the scene or the foreground of the scene.

11. The system of claim 7, wherein the instructions are further configured for:
applying user-configurable effects to the identified region of interest.

12. The system of claim 7, wherein:
the effect comprises at least one of a blur effect, a blank effect and a green screen effect.

13. A non-transitory, computer-readable storage medium embodying computer program code, the computer program code comprising computer executable instructions configured for:
receiving an image video stream from a camera, the image video stream representing a scene;
performing an analysis on the image stream provided by camera to identify a region of interest within the scene, the region of interest corresponding to a portion of the scene, the analysis identifying a first subset of the portion of the scene and a second subset of the portion of the scene;
applying an effect to the first subset of the portion of the scene but not to the second subset of the portion of the scene to provide a modified video stream; and,
providing the modified video stream to an application the modified video stream enhancing privacy of the image video stream due to the effect applied to the first subset of the portion of the scene.

14. The non-transitory, computer-readable storage medium of claim 13, wherein:
the camera comprises a two dimensional camera and a three dimensional camera; and,
the two dimensional camera provides a two dimensional image stream and the three dimensional camera provides a three dimensional image stream.

15. The non-transitory, computer-readable storage medium of claim 13, wherein:
the region of interest comprises a video transmission protected region; and,
the video transmission protected region comprises at least one of potentially sensitive regions and distracting regions in the scene.

16. The non-transitory, computer-readable storage medium of claim 13, wherein:
the identifying a region of interest comprises at least one of automatically detecting video transmission protected regions which are located in at least one of the background of the scene or the foreground of the scene.

17. The non-transitory, computer-readable storage medium of claim 13, wherein the computer executable instructions are further configured for:
applying user-configurable effects to the identified region of interest.

18. The non-transitory, computer-readable storage medium of claim 13, wherein:
the effect comprises at least one of a blur effect, a blank effect and a green screen effect.
